(19) United States
(12) Patent Application Publication
(10) Pub. No.: US 2026/0003330 A1
(43) Pub. Date: Jan. 1, 2026

(54) Furnace Temperature Predictive Modeling

(71) Applicant: Vitro Flat Glass LLC, Cheswick, PA (US)

(72) Inventors: Priyadarshi Mahapatra, Pittsburgh, PA (US); Amin Vahidi-Moghaddam, Pittsburgh, PA (US); Carl Wilson, Pittsburgh, PA (US)

(21) Appl. No.: 19/247,951

(22) Filed: Jun. 24, 2025

Related U.S. Application Data
(60) Provisional application No. 63/664,956, filed on Jun. 27, 2024.

(51) Int. Cl. G05B 13/04

(52) U.S. Cl. CPC G05B 13/048

(57) ABSTRACT

A method for operating a furnace includes: providing a furnace comprising an inlet into which batch materials are fed and an outlet from which a product emerges, the batch materials within the furnace melt to form a molten batch material; monitoring a parameter at which the furnace operates using a sensor to collect operating data, the parameter monitored not including a temperature measurement of the molten batch material in the furnace; inputting the collected operating data into a model configured to generate a predicted temperature of the molten batch material in the furnace at a first time in the future, the model trained on historical operating data of the furnace; generating the predicted temperature of the molten batch material in the furnace at the first time; and automatically adjusting the parameter based on the predicted temperature of the molten batch material in the furnace at the first time.

### CROSS-REFERENCE TO RELATED APPLICATIONS

This application claims priority to U.S. Provisional Application No. 63/664,956 filed Jun. 27, 2024, the disclosure of which is hereby incorporated by reference in its entirety.

### BACKGROUND

### Field

The present disclosure is directed to a method for operating a furnace and a furnace system.

### Technical Considerations

Combustion furnaces often employ physical sensors arranged within the furnace to monitor operating conditions of the furnace. However, these physical sensors only provide current furnace conditions, and their measurements can be severally lagging and lead to sub-optimal future furnace operation.

### SUMMARY OF THE DISCLOSURE

According to some non-limiting aspects of the disclosure, a method for operating a furnace includes: providing a furnace including an inlet into which batch materials are fed and an outlet from which a product produced from the batch material emerges, where the batch materials within the furnace melt to form a molten batch material; monitoring at least one parameter at which the furnace operates using at least one sensor to collect operating data, the at least one parameter monitored not including a temperature measurement of the molten batch material in the furnace; inputting the collected operating data into a model configured to generate a predicted temperature of the molten batch material in the furnace at a first time in the future, the model trained on historical operating data of the furnace; generating, with the model, the predicted temperature of the molten batch material in the furnace at the first time; and automatically adjusting the at least one parameter based on the predicted temperature of the molten batch material in the furnace at the first time.

In some non-limiting aspects, inputs to the inlet may include: a first input including the batch material, a second input including an oxygen-containing stream, and a third input including a fuel-containing stream. The at least one parameter may include at least one of the following: a crown temperature of the furnace, a temperature of gas at the inlet, a flow rate of gas to the furnace, a target amount of product produced, a temperature of the batch material at the inlet, a cullet ratio, an oxygen amount, an environmental variable, a time delay in a production process, and/or any combination thereof. The method may further include generating an energy balance model for the furnace, where the model generates the predicted temperature of the molten batch material in the furnace at the first time based on the energy balance model. The method may further include training the model based on the energy balance model for the furnace and the historical operating data of the furnace. The method may further include: arranging a physical temperature sensor in the molten batch material in the furnace during a training period; operating the furnace to produce the product during the training period; during the training period, collecting the historical operating data of the furnace; and generating the model based on the energy balance model for the furnace and the collected historical operating data of the furnace. The method may further include: after generating the model, deactivating the physical temperature sensor from the molten material in the furnace; and operating the furnace to produce the product during a production period without the physical temperature sensor. The method may further include, during the training period: compartmentalizing the furnace into a plurality of zones; measuring the parameters at which the furnace operates in each of the plurality of zones; and updating the model based on the measured parameters in each of the plurality of zones. Automatically adjusting the at least one parameter may include transmitting a control signal to a component of the furnace to adjust the component of the furnace. The batch material may include a glass batch material, the molten batch material includes a glass melt, and the product may include glass.

In some non-limiting aspects, before monitoring the at least one parameter at which the furnace operates using the at least one sensor to collect operating data, the method may include: monitoring a temperature of the molten batch material in the furnace with a temperature sensor during a first time period; inputting the monitored temperature of the molten batch material in the furnace with the temperature sensor during the first time period into the model configured to generate a predicted temperature of the molten batch material in the furnace at a time in the future relative to the first time period, the predicted temperature of the molten batch material in the furnace at a time in the future relative to the first time period based at least partially on the monitored temperature of the molten batch material in the furnace with the temperature sensor during the first time period. Before monitoring the at least one parameter at which the furnace operates using the at least one sensor to collect operating data, the method may include: taking a first temperature measurement of the molten batch material in the furnace at the first time with a temperature sensor; and determining that the first temperature measurement fails to satisfy a threshold, the method may further include: in response to determining that the first temperature measurement fails to satisfy the threshold, generating, with the model, the predicted temperature of the molten batch material in the furnace at the first time. The method may further include: determining a production schedule change of the furnace, the production schedule change occurring before the first time; inputting the production schedule change to the model; and generating, with the model, the predicted temperature of the molten batch material in the furnace at the first time based at least partially on the production schedule change. The method may further include: determining a desired temperature of the molten batch material in the furnace at the first time; comparing the desired temperature of the molten batch material in the furnace at the first time to the predicted temperature of the molten batch material in the furnace at the first time; determining that adjusting the at least one parameter to an adjusted setpoint is predicted to achieve the desired temperature of the molten batch material in the furnace at the first time; and automatically adjusting the at least one parameter to the adjusted setpoint. The method may further include: determining a type of the product produced from the batch materials, the type of product selected from a plurality of different products; based on the type of product, selecting the model from a plurality of different models, the model trained on historical operating data of the furnace for producing the type of product.

According to some non-limiting aspects of the disclosure, a furnace system includes: a furnace including an inlet into which a batch material is fed and an outlet from which a product produced from the batch material emerges, where the batch materials within the furnace melt to form a molten batch material; at least one sensor configured to monitor at least one parameter at which the furnace operates by collecting operating data, the at least one parameter monitored not including a temperature measurement of the molten batch material being produced in the furnace; and at least one processor configured to: input the collected operating data into a model configured to generate a predicted temperature of the molten batch material in the furnace at a first time in the future, the model trained on historical operating data of the furnace; generate, with the model, the predicted temperature of the molten batch material in the furnace at the first time; and automatically adjust the at least one parameter based on the predicted temperature of the product in the furnace at the first time.

In some non-limiting aspects, inputs to the inlet may include: a first input including the batch material, a second input including an oxygen-containing stream, and a third input including a fuel-containing stream. The at least one parameter may include at least one of the following: a crown temperature of the furnace, a temperature of gas at the inlet, a flow rate of gas to the furnace, a target amount of product produced by the furnace, a temperature of the molten batch material at the inlet, a cullet ratio, an oxygen amount, an environmental variable, a time delay in a production process, and/or any combination thereof. The model may generate the predicted temperature of the molten batch material in the furnace at the first time based on an energy balance model generated for the furnace. The at least one processor may be configured to: train the model based on the energy balance model for the furnace and the historical operating data of the furnace. The system may include: a physical temperature sensor arranged in the molten batch material in the furnace during a training period, the furnace operated to produce the product during the training period, the at least one sensor collecting the historical operating data of the furnace during the training period, and the model generated based on the energy balance model for the furnace and the collected historical operating data of the furnace. After generating the model, the physical temperature sensor may be deactivated from the molten batch material in the furnace, and the furnace may be operated to produce the product during a production period without the physical temperature sensor. During the training period, the furnace may be compartmentalized into a plurality of zones, the at least one sensor may be configured to measure the parameters at which the furnace operates in each of the plurality of zones, and the model may be updated based on the measured parameters in each of the plurality of zones. Automatically adjusting the at least one parameter may include the at least one processor transmitting a control signal to a component of the furnace to adjust the component of the furnace. The batch material may include a glass batch material, the molten batch material may include a glass melt, and the product may include glass.

In some non-limiting aspects, before monitoring the at least one parameter at which the furnace operates using the at least one sensor to collect operating data, the at least one processor may be configured to: monitor a temperature of the molten batch material in the furnace with a temperature sensor during a first time period; input the monitored temperature of the molten batch material in the furnace with the temperature sensor during the first time period into the model configured to generate a predicted temperature of the molten batch material in the furnace at a time in the future relative to the first time period, the predicted temperature of the molten batch material in the furnace at a time in the future relative to the first time period based at least partially on the monitored temperature of the molten batch material in the furnace with the temperature sensor during the first time period. Before monitoring the at least one parameter at which the furnace operates using the at least one sensor to collect operating data, the at least one processor may be configured to: take a first temperature measurement of the molten batch material in the furnace at the first time with a temperature sensor; and determine that the first temperature measurement fails to satisfy a threshold, the at least one processor may be further configured to: in response to determining that the first temperature measurement fails to satisfy the threshold, generate, with the model, the predicted temperature of the molten batch material in the furnace at the first time. The at least one processor may be further configured to: determine a production schedule change of the furnace, the production schedule change occurring before the first time; inputting the production schedule change to the model; and generate, with the model, the predicted temperature of the molten batch material in the furnace at the first time based at least partially on the production schedule change. The at least one processor may be further configured to: determine a desired temperature of the molten batch material in the furnace at the first time; compare the desired temperature of the molten batch material in the furnace at the first time to the predicted temperature of the molten batch material in the furnace at the first time; determine that adjusting the at least one parameter to an adjusted setpoint is predicted to achieve the desired temperature of the molten batch material in the furnace at the first time; and automatically adjust the at least one parameter to the adjusted setpoint. The at least one processor may be further configured to: determine a type of the product produced from the batch materials, the type of product selected from a plurality of different products; based on the type of product, select the model from a plurality of different models, the model trained on historical operating data of the furnace for producing the type of product.

### BRIEF DESCRIPTION OF THE DRAWINGS

The disclosure will be described with reference to the following drawing figures wherein like reference numbers identify like parts throughout.

FIG. 1 shows a schematic diagram of a furnace system according to existing systems;

FIG. 2 shows a schematic diagram of a furnace system, according to some aspects of the disclosure;

FIG. 3 shows a schematic diagram of a compartmentalized furnace system, according to some aspects of the disclosure;

FIG. 4 shows a schematic diagram of a system for operating a furnace, according to some aspects of the disclosure;

FIGS. 5A-5D show schematic diagrams of energy balance models, according to some aspects of the disclosure;

FIG. 6 shows a step diagram of a method for operating a furnace, according to some aspects of the disclosure;

FIGS. 7A-7F show training and validation data for an example system for operating a furnace, according to some aspects of the disclosure.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

Additionally, all documents, such as, but not limited to, issued patents and patent applications, referred to herein are to be considered to be “incorporated by reference” in their entirety.

The disclosure relates to a combustion furnace used in an industrial process. The industrial process can be any industrial process that can use an air and/or oxy-combustion furnace. For example, the furnace can be an air and/or oxy-combustion furnace used to manufacture glass.

A non-limiting background description of a furnace suitable for use in the present disclosure is as follows.

The furnace may be a large capacity furnace. For example, the furnace may be a glass production furnace. The furnace may include a first end or an opening where raw materials can be fed into the furnace (e.g., an inlet). Upon entering the furnace, the raw materials may be heated so as to be melted to form a molten material. The molten material can flow through a second end or discharge end (e.g., an outlet).

The furnace may have a combustion chamber and a melting tank. The melting tank may be in communication with a feeder. The melting tank may be where the raw materials are melted. The feeder may hold unmelted raw materials and provides the unmelted raw materials to the melting tank. Above the melting tank in the furnace may be a combustion chamber. The combustion chamber may comprise one or more burners that provide an oxygen-containing stream and a fuel-containing stream (e.g., a carbon-based fuel) to combust thereby providing heat to melt the materials in the melting tank. The combustion chamber and melting tank may form a melter crown as shown and described herein.

In one non-limiting example, the raw material may be raw glass material (also referred to as “glass batch materials”). The raw glass material may be placed into the furnace at the first end or opening to the furnace by a charging device or feeder. Inside the furnace, the raw glass material may be melted to form molten glass. The molten glass may flow out of the discharge into a fining zone.

A burner may be positioned in openings in the sidewalls of the furnace. The furnace typically has at least two sidewalls—a first sidewall and a second sidewall—wherein the first sidewall is opposite the second sidewall. The sidewall may have openings configured to receive the burner. The burner may be configured to provide an oxygen-containing gas, fuel and/or a mixture of oxygen-containing gas and fuel to the furnace, wherein the fuel combusts to form a flame. The flame from the burner provides the energy to melt the raw material. The burners may extend through a wall of the furnace or through a ceiling of the furnace. The furnace may have burners on one sidewall, or on the first and second sidewalls. The furnace may have at least 4, at least 6, at least 8, at least 10, or at least 12 burners; and/or at most 30 burners, at most 24 burners, at most 20 burners, or at most 16 burners. The burners on the first sidewall can be staggered (as opposed to in line) with the burners on the second sidewall.

The furnace may be an air and/or oxy-combustion furnace. The burners may be placed on the side walls at a certain distance from the surface of the molten material to provide suitable distribution of energy to melt the raw glass materials. For example, the burners can be at least 0.25 m, or at least 0.40 m, and less than 1.0 m or 0.8 m from the surface of the molten material.

The oxygen-containing gas may comprise pure oxygen, air, or some other oxygen-nitrogen gas blend.

The fuel-containing stream may comprise any hydrocarbon commonly burned in industrial furnaces. Non-limiting examples of fuel-containing streams include natural gas, fuel oil, coke, coal, or diesel.

The combustion process may form an exhaust gas in the combustion chamber. The exhaust gas may contain NOx gases. The NOx gases may be formed by oxygen reacting with nitrogen gas. The reaction may occur due to the high temperatures present in the furnace.

In some non-limiting embodiments or aspects, the furnace may include an electric heated furnace. The electric heated furnace may comprise at least one electrode that penetrates into the molten batch material to heat the furnace. The heat emitted by the electrodes may be energy transferred from the combustion space to the molten batch materials. The furnace may be a hybrid of an electric heated furnace and an air and/or oxy-combustion furnace.

While furnaces used in glass production have been described herein, it will be appreciated that furnaces used in other applications are also within the scope of the present disclosure, such as furnaces used in metallurgical applications, furnaces used to conduct chemical reactions, furnaces used in hydrocarbon refining, and the like.

The present disclosure is directed to a method for operating a furnace, such as a furnace comprising any of the forgoing components, using a model. The method may comprise: providing a furnace comprising an inlet into which batch materials are fed and an outlet from which a product produced from the batch material emerges, wherein the batch materials within the furnace melt to form a molten batch material; monitoring at least one parameter at which the furnace operates using at least one sensor to collect operating data, the at least one parameter monitored not comprising a temperature measurement of the molten batch material in the furnace; inputting the collected operating data into a model configured to generate a predicted temperature of the molten batch material in the furnace at a first time in the future, the model trained on historical operating data of the furnace; generating, with the model, the predicted temperature of the molten batch material in the furnace at the first time; and automatically adjusting the at least one parameter based on the predicted temperature of the molten batch material in the furnace at the first time.

The present disclosure is directed to a furnace system comprising any of the forgoing components, the furnace system including a model. The furnace system may comprise: a furnace comprising an inlet into which a batch material is fed and an outlet from which a product produced from the batch material emerges, wherein the batch materials within the furnace melt to form a molten batch material; at least one sensor configured to monitor at least one parameter at which the furnace operates by collecting operating data, the at least one parameter monitored not comprising a temperature measurement of the molten batch material being produced in the furnace; and at least one processor configured to: input the collected operating data into a model configured to generate a predicted temperature of the molten batch material in the furnace at a first time in the future, the model trained on historical operating data of the furnace; generate, with the model, the predicted temperature of the molten batch material in the furnace at the first time; and automatically adjust the at least one parameter based on the predicted temperature of the product in the furnace at the first time.

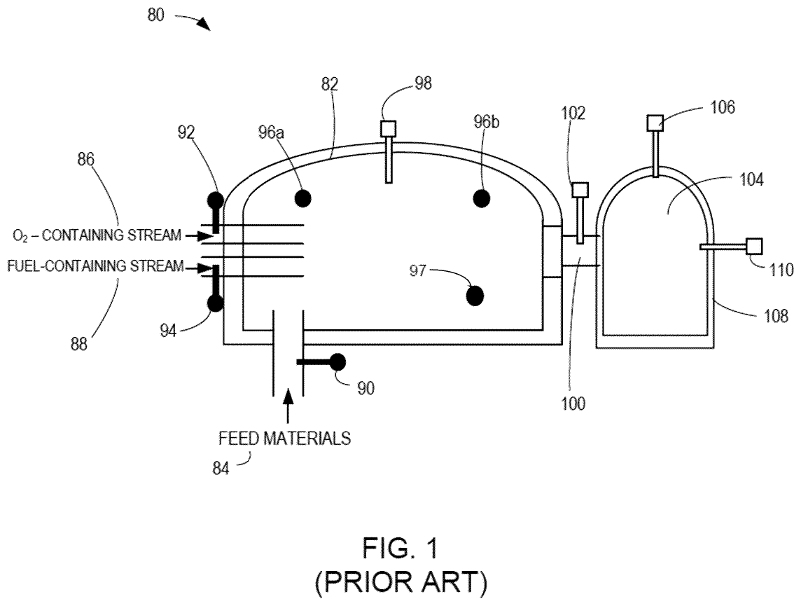

Referring to FIG. 1, a furnace system 80 is shown according to existing systems. While the present disclosure describes the specific design of a furnace system 80 shown in FIGS. 1-3, it will be appreciated that its design is non-limiting and other furnace designs are within the scope of the present disclosure.

The furnace system 80 of FIG. 1 may comprise a melter crown 82 in which the feed materials are fed and melted. The melter crown 82 may comprise feed materials input 84 through which feed materials are fed to the melter crown 82. The feed materials may comprise any materials intended to be melted by the furnace. A non-limiting example of feed materials comprise glass batch materials used to make glass substrates. A non-limiting list of glass batch materials comprise at least one of SiO₂, Na₂O, CaO, MgO, Al₂O₃, K₂O, FeO, Fe₂O₃, SO₃, Cr₂O₃, MnO, MnO₂, TiO₂, CeO₂, B₂O₃, NiO, Li₂O, CoO, V₂O₅, BaO, Cu, CuO, Co, Co₃O₄, Se, C, SnO₂, ZrO₂, Nd₂O₃, Er₂O₃, Sb₂O₃, As₂O₃, ZnO, NaNO₃, and the like. The glass batch materials may comprise limestone, dolomite, and/or sand. The glass batch materials may comprise recycled glass mixed back into the raw materials (e.g., cullet), which may melt with the glass batch materials in the furnace, or the glass batch materials may not include cullet. In some non-limiting embodiments, the glass batch materials and the cullet may be separate components. Other non-limiting examples of other raw materials that may be fed into the melter crown 82 include reactants of a chemical reaction, metal materials (e.g., for smelting), and hydrocarbons for refining.

The melter crown 82 may comprise an oxygen-containing stream input 86 through which the oxygen-containing stream is fed to the melter crown 82. The oxygen-containing stream may comprise pure oxygen, air, or some other oxygen-nitrogen gas blend.

The melter crown 82 may comprise a fuel-containing stream input 88 through which the fuel-containing stream is fed to the melter crown 82. The fuel may comprise any of the previously listed hydrocarbon fuels.

With continued reference to FIG. 1, each of the feed materials input 84, the oxygen-containing stream input 86, and the fuel-containing stream input 88 may comprise a respective flow meter 90, 92, 94 configured to directly measure the flow rate of the feed materials, oxygen-containing stream, and fuel-containing stream into the melter crown 82. Each of the feed materials input 84, the oxygen-containing stream input 86, and the fuel-containing stream input 88 may also comprise a valve (not shown) configured to control the amount of feed materials, oxygen-containing stream, and fuel-containing stream fed into the melter crown 82. The valves may be automatically controlled by a controller (not shown).

The melter crown 82 may also comprise temperature sensors 96a, 96b arranged therein to directly measure a temperature in a particular region in the furnace. The non-limiting example in FIG. 1 shows two temperature sensors 96a, 96b, including a first temperature sensor 96a measuring the temperature in the melter crown 82 in a first region and a second temperature sensor 96b measuring the temperature in the melter crown 82 in a second region. It will be appreciated that other embodiments may include only a single temperature sensor, while still other embodiments may include three or more temperature sensors. The melter crown 82 (or any other region of the furnace) may also comprise a molten batch temperature sensor 97 arranged in the molten batch and configured to directly measure a temperature of the molten batch. While a single molten batch temperature sensor 97 is shown, it will be appreciated that a plurality of molten batch temperature sensors 97 may be arranged throughout the furnace system 80 to measure the temperature of the molten batch at different locations.

The melter crown 82 may further comprise a physical sensor 98 configured to directly measure the combustion product in the melter crown 82. For example, the physical sensor 98 may be an oxygen sensor to directly measure oxygen composition in the melter crown 82. The combustion product may be any of those combustion products previously listed. While the physical sensor 98 in FIG. 1 is arranged in the crown of the melter crown 82, it will be appreciated that the physical sensor 98 may be positioned in one or more other regions of the melter crown 82 to directly measure the combustion product.

With continued reference to FIG. 1, the furnace system 80 may further comprise a port neck 100 comprising a port neck physical sensor 102 configured to directly measure combustion product therein. The port neck 100 may connect the melter crown 82 to one or more regenerator crowns 104.

The furnace system 80 may further comprise the regenerator crown 104 comprising a regenerator crown physical sensor 106 configured to directly measure combustion product therein. The regenerator crown 104 may comprise a target wall 108 comprising a target wall physical sensor 110 configured to directly measure combustion product at the target wall 108.

The furnace system 80 may comprise an outlet (not shown) from which a product (e.g., glass) produced from the batch material emerges.

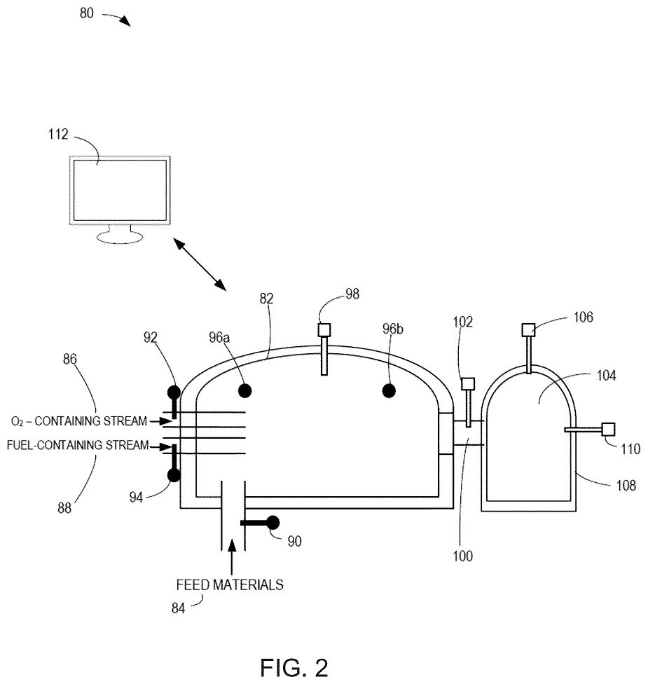

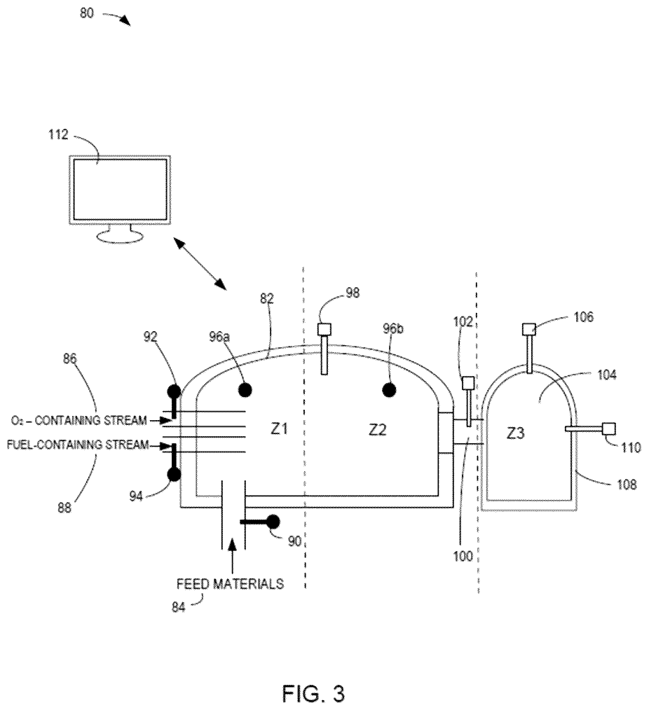

Referring to FIGS. 2 and 3, furnace systems 80 having a model system 112 are shown according to some aspects of the disclosure. The furnace systems 80 of FIGS. 2 and 3 may include the same or similar components as the furnace system 80 of FIG. 1 except as described hereinafter.

The furnace systems 80 of FIGS. 2 and 3 may further comprise the model system 112 in communication with a controller (not shown) of the furnace system 80. The model system 112 may replace and/or augment the molten batch temperature sensor 97 of the furnace system 80 configured to directly measure the temperature of the molten batch. While the non-limiting examples of FIG. 2 or 3 show the model system 112 replacing and/or augmenting the molten batch temperature sensor 97 of the melter crown 82, it will be appreciated that the model system 112 may additionally or alternatively replace and/or augment a molten batch temperature sensor arranged in at least one of the port neck 100, the regenerator crown 104, the target wall 108, and the like.

Referring to FIG. 2, the furnace system 80 may comprise the model system 112 with the molten batch temperature sensor 97 (see FIG. 1), removed from the melter crown 82. The molten batch temperature sensor 97 may be fully removed from the melter crown 82 so as to protect the molten batch temperature sensor 97 from the harsh conditions in the melter crown 82 and/or molten batch and thus extend the life of the molten batch temperature sensor 97. In some non-limiting embodiments, the molten batch temperature sensor 97 may be re-inserted into the melter crown 82 periodically to evaluate the deviation of the model system 112 and/or to recalibrate the model system 112.

In some non-limiting embodiments or aspects, the furnace system 80 may comprise the model system 112 with the molten batch temperature sensor 97 retracted from the melter crown 82. The molten batch temperature sensor 97 being retracted from the melter crown 82 may protect the molten batch temperature sensor 97 from the harsh conditions in the melter crown 82 and/or molten batch and thus extend the life of the molten batch temperature sensor 97. In some non-limiting embodiments, the molten batch temperature sensor 97 may be unretracted into the melter crown 82 periodically to evaluate the deviation of the model system 112 and/or to recalibrate the model system 112.

In some non-limiting embodiments or aspects, the molten batch temperature sensor 97 may remain in the position shown in FIG. 1, but merely be deactivated (e.g., not measuring and/or reporting temperature) in favor of the model system 112 being used. In some non-limiting embodiments, the molten batch temperature sensor 97 and the model system 112 may be used to measure or report temperature of the molten batch simultaneously, such as during recalibration of the model system 112. In some non-liming embodiments, the molten batch temperature sensor 97 may remain in the position shown in FIG. 1, but the molten batch temperature sensor 97 may be covered by a separate component to protect the physical sensor from the harsh conditions in the melter crown 82 and/or molten batch.

Referring to FIG. 3, the furnace system 80 shown therein may include the same or similar components as the furnace system 80 of FIG. 2 except as described hereinafter. The furnace system of FIG. 3 may be compartmentalized by being divided into a plurality of zones Z1-Z3. A physical barrier may be arranged between each of the zones Z1-Z3 or the zones Z1-Z2 may be arbitrarily defined and not physically separated from one another. Although 3 zones Z1-Z3 are shown in FIG. 3, it will be appreciated that the furnace system 80 may be divided up into any number of zones. Further, the furnace system 80 may be divided up into zones Z1-Z3 in any suitable manner, including compartmentalizations of the furnace system 80 different than the arrangement shown in FIG. 3. Each of the zones Z1-Z3 may have suitable sensors that detect conditions in the furnace in that zone by the model system 112 to control the furnace system 80. The same parameter may be measured in each of the plurality of zones Z1-Z3 to track changes to that parameter throughout the furnace system 80.

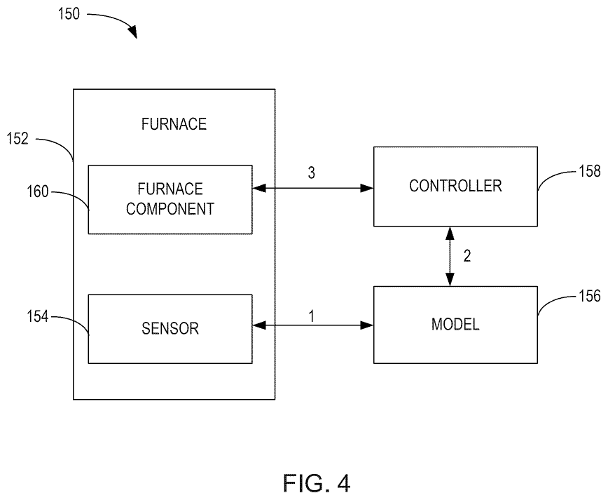

Referring to FIG. 4, a system 150 for operating a furnace is shown, according to some aspects of the disclosure. The system 150 may comprise a furnace 152, such as the furnace in the furnace system 80 shown in FIGS. 2-3.

The furnace 152 may comprise a sensor 154, such as any of the sensors in the furnace system 80 shown in FIGS. 1-3. The sensor 154 may monitor (e.g., measure) at least one parameter at which the furnace 152 operates. The sensor may measure the at least one parameter continuously and/or periodically. The sensor 154 may collect (e.g., via measurement) operating data of the furnace 152 associated with the at least one parameter at which the furnace 152 operates. The sensor 154 may store in a database (not shown) the collected operating data of the furnace 152.

The at least one parameter being monitored by the sensor 154 may be any parameter suitable for use by a model to control the furnace 152. Non-limiting examples of parameters include at least one of the following: a crown temperature of the furnace, a temperature of gas at the inlet, a flow rate of gas to the furnace, a target amount of product produced, a temperature of the batch material at the inlet, a cullet ratio, an oxygen amount, an environmental variable (e.g., an environmental variable that impacts a temperature in the furnace, such as a temperature of the molten batch material), a time delay in a production process, and/or any combination thereof. The type of sensor 154 (e.g., temperature sensor, weight sensor, mass sensor, flow rate sensor, concentration sensor, amount sensor, level sensor, and the like) used to monitor the parameter may depend on the type of parameter being monitored.

The sensor 154 monitoring the at least one parameter at which the furnace 152 operates to collect operating data may not comprise a temperature measurement of the molten batch material in the furnace 152 (e.g., not be from the molten batch temperature sensor 97 from FIG. 1). A temperature from the molten batch temperature sensor 97 may not be an input used by a model to operate the furnace 152 during the production cycle (e.g., a non-training cycle).

With continued reference to FIG. 4, the sensor 154 may transmit the collected operating data of the furnace 152 to a model 156 as input to the model 156. The model 156 may comprise the model system 112 from FIGS. 2-3. Based on the input, the model 156 may be configured to generate a predicted temperature of the molten batch material in the furnace 152 at a first time in the future. As such, the model 156 may predict future temperatures of the molten batch material. The model 156 may be trained on historical operating data as described herein.

The first time in the future (for which the prediction is being made) may be any suitable time after the prediction is generated, such as seconds, minutes, days, weeks, or months after the prediction. For example, the prediction may be for at least 1 week, such as at least 2 weeks, or at least 4 weeks in the future. The model 156 may be capable of accurately predicting a future temperature of the molten batch materials in the future up until a significant change is made to properties of the system that may not have been accounted for by the model 156 during training. For example, using the system for a different product run or in different environmental conditions may require further training of the model 156 before accurate predictions for the unaccounted for conditions can be made.

In response to receiving the input, the model 156 may generate the predicted temperature of the molten batch material in the furnace 152 at the future first time. The model 156 may predict the temperature of the molten batch material at the time in the future before that time in the future. For example, the model 156 may predict at a present time what the temperature of the molten batch material will be at a future time. The model 156 may generate the predicted future temperature of the molten batch material using an algorithm (as described herein) generated by the model 156 during a training period (as described herein).

With continued reference to FIG. 4, the model 156, a controller 158, or another control component of the system 150 may determine an automated response to the predicted future temperature of the molten batch material generated by the model 156. The automated response may be based on at least one model-based control algorithm, for example, a multi-step predictive control utilizing control optimization such as quadratic programming. The automated response may be based on an association between a predicted future temperature of the molten batch material with one or more suitable automated responses generated by the model 156 based on training of the model 156 on historical operating data.

With continued reference to FIG. 4, the controller 158 may be configured to automatically adjust the at least one parameter based on the predicted temperature of the molten batch material in the furnace 152 at the first time. Automatically adjusting the at least one parameter may comprise transmitting a control signal to a component 160 of the furnace 152 to adjust the component 160 of the furnace 152. The model 156 may have determined that adjusting the component 160 of the furnace 152 would cause the adjusting the at least one parameter the model 156 determines should be adjusted in order to get a desired (e.g., predetermined) future temperature of the molten batch material.

For example, if the predicted temperature of the molten batch material in the furnace 152 at the first time is higher than the desired future temperature of the molten batch material in the furnace 152 at the first time, the adjustment of the parameter and/or the component 160 may be initiated that is expected to lower the future temperature of the molten batch material in the furnace 152 at the first time to the desired level. For example, if the predicted temperature of the molten batch material in the furnace 152 at the first time is lower than the desired future temperature of the molten batch material in the furnace 152 at the first time, the adjustment of the parameter and/or the component 160 may be initiated that is expected to raise the future temperature of the molten batch material in the furnace 152 at the first time to the desired level.

The parameter automatically adjusted may be any of the previously listed parameters that may be monitored by the sensor 154. The sensor 154 may continue to monitor the parameter to ensure that the adjustment has the desired effect on the value of the parameter. The parameter monitored and/or controlled may not comprise a direct temperature measurement of the molten batch material in the furnace 152, such that a direct monitoring the temperature of the molten batch material is not used by the system 150 during the production cycle, and the system may indirectly measure the temperature of the molten batch material by monitoring other parameters of the system 150 and modeling the relationship between those other parameters and the temperature of the molten batch material.

The component 160 adjusted by the controller 158 (e.g., by the control signal) to adjust the parameter may comprise any suitable physical component of the furnace system. For example, the component 160 may comprise at least one of the following: a valve, a pump, a heating element, a cooling element, a timing element and/or any combination thereof. For example, a flow rate may be adjusted by adjusting an amount a valve is opened and/or closed and/or a rate at which a pump causes the material to flow. For example, a temperature may be adjusted by adjusting the operation of a heating and/or cooling element and/or an amount of the combustible material fed to the system. It will be appreciated that adjustment of any suitable component 160 of the system 150 to effect the adjustment to the parameter may be initiated by the controller 158.

In some non-limiting embodiments or aspects, the parameter to be adjusted may be the crown temperature of the furnace 152. Crown temperature may be adjusted, for example by adjusting a flow rate and/or an amount of one or more materials to the inlet of the furnace, such as to the batch material, the oxygen-containing stream, and/or the fuel-containing stream.

In some non-limiting embodiments or aspects, the controller 158 may be configured to automatically adjust the at least one parameter based on the predicted temperature of the molten batch material in the furnace 152 at the first time by generating a control signal configured to initiate an alarm. The control signal may cause an alarm to display and/or emit a visual and/or audible output to notify a user of an adjustment to be made to the system 150. The control signal may cause an alarm to be generated and displayed on a computing device of a user (e.g., on a graphical user interface). The displayed alarm may indicate that an adjustment of one or more components 160 should be made to adjust the parameter.

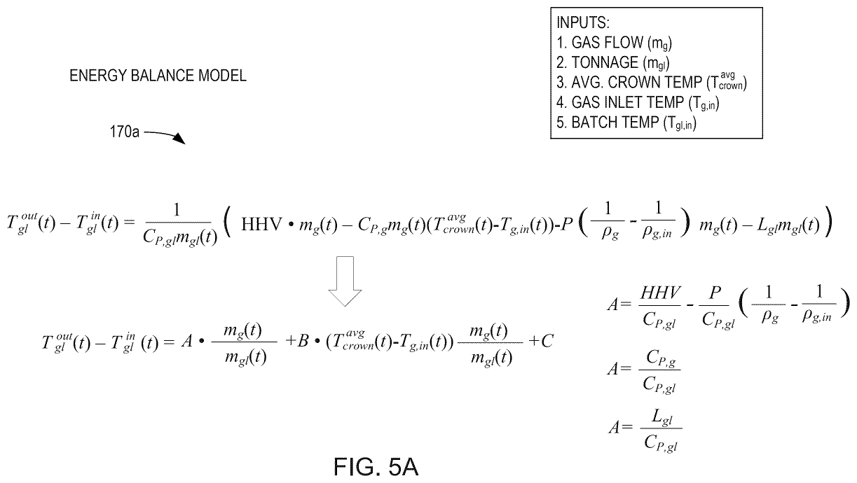

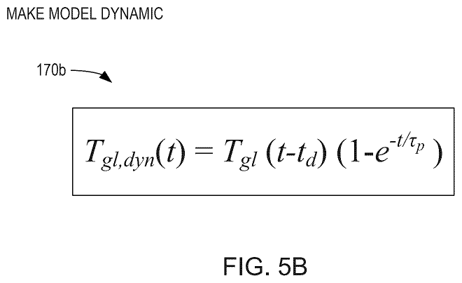

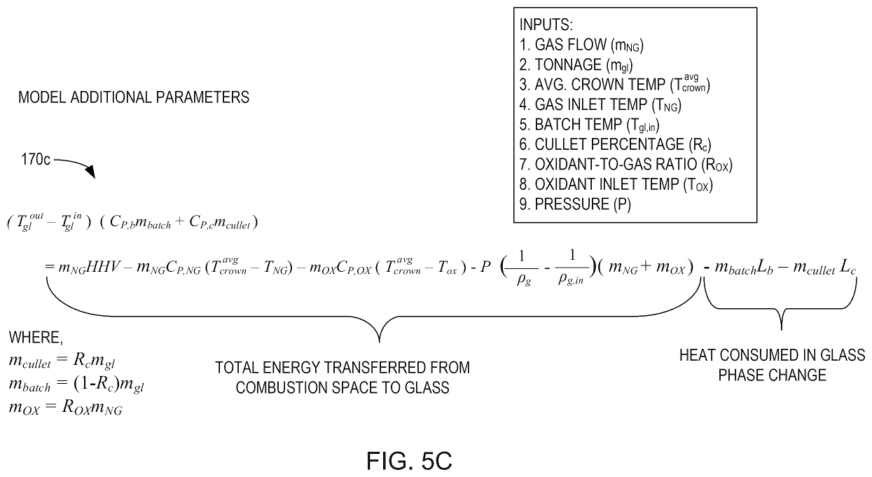

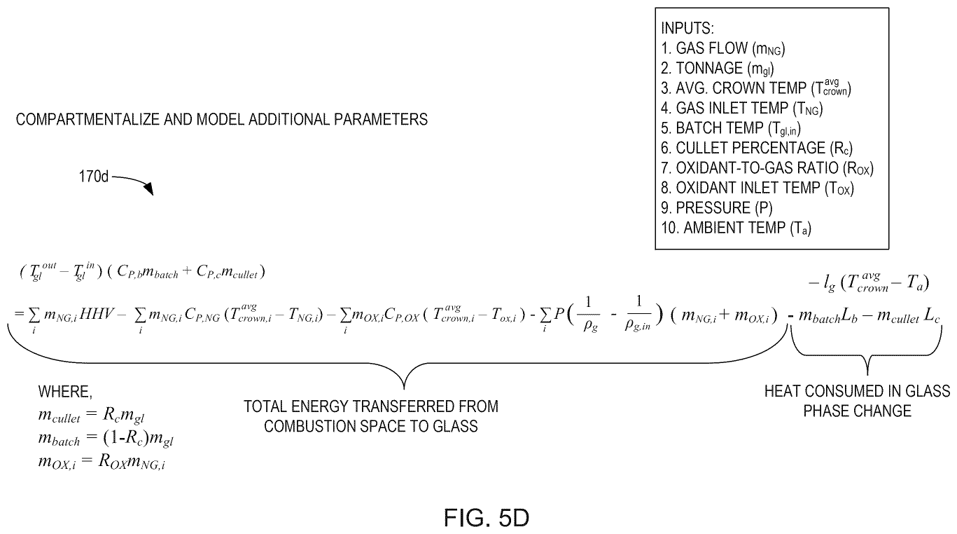

Referring to FIGS. 4-5D, the model 156 may generate predicted temperature of the molten batch material in the furnace 152 at the first time using any suitable modeling technique. The model 156 may comprise a machine learning algorithm and/or use any other suitable fitting programs. The model 156 may comprise a physics-based model.

Non-limiting examples of machine learning models that may be used for the model 156 include linear neural networks, although it will be appreciated that other types of machine learning models may be used. The linear neural network may be history-dependent.

The model 156 may comprise a recurrent neural network (RNN) that may iteratively update hidden states to store memory and predict sequential events. A rectified linear unit (ReLU) activation function may be applied to the inputs by the model 156 in generating the output. For example, an RNN may apply a ReLU activation function in generating its output. The RNN may make recursive predictions based on its previous predictions rather than actual measurements, which may enable the system to account for potential sensor failures and enable the controller to determine inverse calculations/optimizations.

In some non-limiting embodiments or aspects, the model 156 may generate an energy balance model for the furnace 152. The model 156 may generate a predicted temperature of the molten batch material in the furnace at the first time based on the energy balance model.

FIGS. 5A-5D show examples of a modeling process using non-limiting examples of energy balance models 170a-d.

FIG. 5A shows a non-limiting example of a static energy balance model 170a that may be used by the model 156 to predict a future temperature of the of the molten batch material.

FIG. 5B shows a non-limiting example of a dynamic component of an energy balance model 170b that may be used by the model 156 to predict a future temperature of the of the molten batch material, which incorporate process dynamics, such as time delays and/or dead times. Accounting for dynamic components of the process may enhance the accuracy of the output of the model 156.

FIG. 5C shows a non-limiting example of an energy balance model 170c that may be used by the model 156 to predict a future temperature of the of the molten batch material. The energy balance model 170c may model additional measured furnace conditions as inputs compared to the energy balance model 170a from FIG. 5A.

FIG. 5D shows a non-limiting example of an energy balance model 170d that may be used by the model 156 to predict a future temperature of the of the molten batch material. The energy balance model 170d may compartmentalize the furnace into zones (see FIG. 3) as inputs compared to the energy balance models 170a, 170c from FIGS. 5A, 5C.

The various variables from the energy balance models 170a-d are labeled in the following table:

Equation Variables

| Symbol | Variable |
|---|---|
| T_{gl}^{out} | Batch outlet temperature (e.g., glass leaving furnace) |
| T_{gl}ⁱⁿ | Batch inlet temperature (e.g., of cullet and batch materials) |
| C_{P, gl} | Heat capacity of the glass at constant pressure |
| m_{gl} | Tonnage (e.g., of batch and cullet entering system) |
| HHV | Higher heating value |
| m_{g} | Gas flow (e.g., mass of the gas) |
| C_{P, g} | Heat capacity of the gas at a constant pressure |
| T_{g, in} | Gas inlet temperature |
| P | Pressure |
| ρ_{g} | Density of glass |
| ρ_{g, in} | Density of gas inlets |
| L_{gl} | Latent heat of gas |
| T_{gl, dyn} | Temperature of glass with process dynamics |
| T_{gl} | Temperature of glass |
| t_{d} | Time step of the model |
| τₚ | Response from change |
| C_{P, b} | Heat capacity of batch at constant pressure |
| C_{P, c} | Heat capacity of cullet at constant pressure |
| m_{batch} | Mass of batch in |
| m_{cullet} | Mass of cullet in |
| m_{NG} | Mass of gas in |
| C_{P, NG} | Heat capacity of gas in at constant pressure |
| T_{NG} | Gas inlet temperature |
| m_{OX} | Mass oxygen |
| C_{P, OX} | Heat capacity of oxygen at constant pressure |
| T_{OX} | Oxidant inlet temperature |
| L_{b} | Latent heat of batch |
| L_{c} | Latent heat of cullet |
| R_{c} | Cullet percentage |
| R_{OX} | Oxidant-to-gas ratio |
| i | i-th compartment of furnace |
| l_{g} | Furnace heat loss coefficient |
| T_{crown}^{avg} | Average crown temperature |
| Tₐ | Ambient temperature |

Referring to FIGS. 2-4, the model 156 (e.g., model system 112) may be trained based on the energy balance model for the furnace 152 (see e.g., energy balance models 170a-d) and historical operating data of the furnace 152.

The historical operating data for the furnace 152 may be obtained as follows, with particular reference to FIG. 1. In the furnace system 80 of FIG. 1, a physical temperature sensor that is a molten batch temperature sensor 97 may be arranged in the molten batch material of the furnace 152 during a training period. The furnace 152 may be operated during the training period to enable the molten batch temperature sensor 97 to collect historical operating data of the furnace 152 related to the temperature of the molten batch material during the training period. Other sensors arranged in the furnace system 80 during the training period may collect historical operating data related to other parameters (e.g., the parameters previously described herein) of the furnace 152 during the training period. This historical operating data of the furnace 152 collected during the training period may be used by the model 156 to generate an algorithm that enables the model 156 to generate predictions for the future temperature of the molten batch material during a production cycle (e.g., after the training period) without the molten batch temperature sensor 97 (e.g., without having and/or using direct measurements of the temperature of the molten batch material from the molten batch temperature sensor 97 to generate future temperature predictions). The energy balance model may also be used to generate the algorithm.

It will be appreciated that each different furnace system may be trained in this manner. It will be further appreciated that the same furnace system may be trained in this manner for each different product the furnace 152 will produce and/or for each different set of conditions and/or environment in which the furnace 152 will produce a product.

Referring again to FIGS. 2-4, after training of the model 156 has been completed (and/or re-training of the model which may occur continuously and/or periodically), the molten batch temperature sensor 97 (from FIG. 1) may be deactivated. Deactivating the molten batch temperature sensor 97 may include removing the molten batch temperature sensor 97 completely from the system and/or retracting the molten batch temperature sensor 97 during the production cycle. Deactivating the molten batch temperature sensor 97 may include covering the molten batch temperature sensor 97 such that the molten batch temperature sensor 97 cannot measure temperature of the molten batch material. Deactivating the molten batch temperature sensor 97 may include leaving the molten batch temperature sensor 97 in place but disabling or turning off the molten batch temperature sensor 97. Deactivating the molten batch temperature sensor 97 may include leaving the molten batch temperature sensor 97 in place but not measuring and/or reporting temperature measured thereby. Deactivating the molten batch temperature sensor 97 may include leaving the molten batch temperature sensor 97 in place but not using the temperature measured thereby to generate the prediction of the future temperature of the molten batch material.

With continued reference to FIGS. 2-4, after deactivation of the molten batch temperature sensor 97, the furnace 152 may be operated in a production cycle to produce a product without the model 156 using a direct temperature measurement of the molten batch material to generate the prediction of the future temperature of the molten batch material.

Referring to FIGS. 3 and 4, the furnace system 80 (e.g., the furnace 152 thereof) may be compartmentalized into a plurality of zones Z1-Z3 (see FIG. 3) as previously described. During the training period, the parameters at which the furnace operates in each of the plurality of zones Z1-Z3 may be measured by sensors. For example, a molten batch sensor in each of the plurality of zones Z1-Z3 may measure the temperature of the molten batch material in each of the zones Z1-Z3. The same parameter(s) may be measured in each of the zones Z1-Z3 to determine how the parameter changes in the zones Z1-Z3.

The measurements taken in the zones Z1-Z3 during the training period may be input and used to generate and/or update the model 156. Division of the furnace system 80 into zones Z1-Z3 and measurement of parameters in each zone may enhance the accuracy of the algorithm generated by the model 156 used during the production cycle.

In some non-limiting examples, a furnace may be divided into a melt zone, a peak zone, and a waist zone. In the melt zone the batch and/or cullet enter the system. In the peak zone (e.g., a center portion of the furnace) the batch material (and cullet) is fully melted into the molten batch material. In the waist zone the product exits the furnace. Historical operating data of the furnace may be collected in each of these zones during the training period and used to generate the model.

In some non-limiting embodiments or aspects, the molten batch temperature sensor 97 may be periodically re-activated (e.g., during a re-training period and/or during the production cycle) to monitor the integrity of the model 156 (e.g., the accuracy of the predictions generated thereby). The updated data measured by the molten batch temperature sensor 97 during this period may be input to the model 156 to re-train and/or adjust the model 156. The model 156 may weight newer operating data more heavily compared to older operating data during the re-training.

In some non-limiting embodiments or aspects, the model 156 may determine that a sensor and/or a component of the system is faulty and in need of maintenance and/or replacement. For example, the temperature prediction of the model 156 may indicate that the molten batch temperature sensor 97 is faulty. For example, the temperature prediction of the model 156 may indicate that a different sensor from the molten batch temperature sensor 97 is faulty. An alert of the faulty sensor and/or component may be generated by the model 156.

In some non-limiting embodiments or aspects, the product produced by the furnace may comprise glass, the batch material provided to the furnace 152 may be glass batch material, and the molten batch material produced in the furnace 152 may be a glass melt. It will be appreciated that the furnace 152 may be used to produce non-glass products, such as products produced from furnaces 152 running metallurgical applications, chemical reactions, hydrocarbon refining, and the like.

In some non-limiting embodiments or aspects, before monitoring the at least one parameter at which the furnace operates using the at least one sensor to collect operating data, a temperature of the molten batch material in the furnace may be monitored with a temperature sensor during a first time period (e.g., initially directly monitoring temperature of the molten batch material). This monitored temperature may be input to the model configured to generate a predicted temperature of the molten batch material in the furnace at a time in the future relative to the first time period. The predicted temperature of the molten batch material in the furnace at a time in the future relative to the first time period may be based at least partially on the monitored temperature of the molten batch material in the furnace with the temperature sensor during the first time period.

For example, a predicted temperature at time k may be represented by ŷₖ, and a measured temperature at time k may be represented by yₖ. Because the predicted temperature at time k may be based on historic monitored temperatures of the molten batch material in the furnace during a first time period, the a predicted temperature at time k may be represented by the following equation: ŷₖ=g(uₖ, uₖ₋₁, uₖ₋₂, . . . , uₖ₋ₕ, yₖ₋₁). In this equation, a history of last h samples plus one previous output (e.g., predicted output of the model) may be included to capture the process delay and dead-time.

A future predicted temperature at time k+1 may be represented by ŷₖ₊₁.

The future predicted temperature at time k+1 may be represented by the following function when the current measured molten batch material temperature is measured and/or available: ŷₖ₊₁=g(uₖ₊₁, uₖ, uₖ₋₁, . . . , uₖ₋ₕ₊1, yₖ).

The future predicted temperature at time k+1 may be represented by the following function when the current measured glass temperature is not measured and/or available, such that predicted molten batch material temperature is used instead: ŷₖ₊₁=g(uₖ₊₁, uₖ, uₖ₋₁, . . . , uₖ₋ₕ₊₁, ŷₖ). The future predicted temperature at time k+2 may be represented by the following function when the current measured glass temperature is not measured and/or available, such that predicted molten batch material temperature is used instead: ŷₖ₊₂=g(uₖ₊₂, uₖ₊₁, uₖ, . . . , uₖ₋ₕ₊₂, ŷₖ₊₁).

In some non-limiting embodiments or aspects, a change to the production schedule of the furnace may impact future predicted temperatures of the molten batch materials. A production scheduling change may comprise a change to at least one parameter at which the furnace is operated, such as a change to at least one of the following: a crown temperature of the furnace, a temperature of gas at the inlet, a flow rate of gas to the furnace, a target amount of product produced, a temperature of the batch material at the inlet, a cullet ratio, an oxygen amount, an environmental variable, a time delay in a production process, and/or any combination thereof. The predicted scheduling change may comprise a change to the product being produced by the furnace (e.g., from a first product to a different second product).

In generating the predicted temperature of the molten batch materials, the at least one processor may determine a production schedule change of the furnace, the production schedule change occurring before the first time.

The production schedule change may be input to the model, such as by inputting one or more parameters associated with the production schedule change. The one or more parameters may include a change to the parameter, a time at which the change occurred, a magnitude of the change, and the like. The model may generate the predicted temperature of the molten batch material in the furnace at the first time based at least partially on the production schedule change.

In some non-limiting embodiments or aspects, before monitoring the at least one parameter at which the furnace operates using the at least one sensor to collect operating data, a temperature sensor may take (e.g., directly) a first temperature measurement of the molten batch material in the furnace at the first time. It may be determined that the first temperature measurement fails to satisfy a threshold. For example, the at least one processor may compare the first temperature measurement to a previous temperature measurement and/or an expected temperature measurement and determine that the first temperature measurement may contain an error, such as by being different by more than a threshold amount and/or percent from the previous temperature measurement and/or an expected temperature measurement. The at least one processor may automatically shift from monitoring temperature using the temperature sensor to using the model to generate temperature predictions based on a determination that the temperature sensor may be malfunctioning. In some non-limiting embodiments or aspects, an operator may monitor the first temperature measurement and determine that the temperature sensor may be malfunctioning. In response, the operator may shift from monitoring temperature using the temperature sensor to using the model to generate temperature predictions. For example, in response to determining that the first temperature measurement fails to satisfy the threshold, the model may be used to generate the predicted temperature of the molten batch material in the furnace at the first time.

In some non-limiting embodiments or aspects, the system may determine a desired temperature of the molten batch material in the furnace at the first time. For example, an operator may input a desired temperature of the molten batch material in the furnace at the first time and/or the controller may automatically determine the desired temperature, such as based on an optimization output and/or the product to be produced by the furnace. In response to determining the desired temperature and the predicted temperature of the molten batch material in the furnace at the first time, the two values may be automatically compared. Based on the comparison, the model may automatically determine that adjusting the at least one parameter to an adjusted setpoint is predicted (e.g., by the model) to achieve the desired temperature of the molten batch material in the furnace at the first time. This may be effected by the model perturbing different parameters and predicting the perturbation's impact on the temperature of the molten batch material at the first time (e.g., an updated prediction) to determine whether the perturbation causes the updated prediction to equal the desired temperature. The controller may automatically adjust the at least one parameter to the adjusted setpoint. This may occur automatically in response to the model automatically determining the parameter(s) that should be adjusted to achieve the desired temperature at the first time.

In response to the model automatically determining the parameter(s) that should be adjusted to achieve the desired temperature at the first time, the controller may automatically adjust the parameter(s). This sequence may be initiated and automatically implemented when the system operates in an automatic mode.

In other non-limiting embodiments or aspects, in response to the model automatically determining the parameter(s) that should be adjusted to achieve the desired temperature at the first time, the model may generate a recommendation message that contains a recommendation as to how to adjust the parameter(s) to achieve the desired temperature. The recommendation message may be transmitted to an operator device. In response to receiving the recommendation message, the operator may manually adjust the parameters (or forego doing so) based on the recommendation message. In response to receiving the recommendation message, the operator may instruct the controller to automatically adjust the parameters (or forego doing so), which controller may cause the parameters to be adjusted or not adjusted.

In some non-limiting embodiments or aspects, the system may determine a type of the product produced from the batch materials. The type of product may be selected from a plurality of different products. A different type of product may comprise a product made from one or more different raw material, one or more different amounts of the same raw materials, one or more different process step and/or order of process steps, and/or the like. The system may automatically determine the product type based on the input to the furnace and/or the process conditions under which the furnace is instructed to operate. The operator may notify the system of the type of product being produced by the furnace.

Based on the type of product, the controller may select the model from a plurality of different models. The system may comprise a catalog of a plurality of different models, and each model may be trained based on one or more different products. For example, the model may be trained on historical operating data of the furnace for producing the determined type of product. In response to determining the type of product and the model corresponding to that product, the data may be input to the relevant model to generate the predicted temperature.

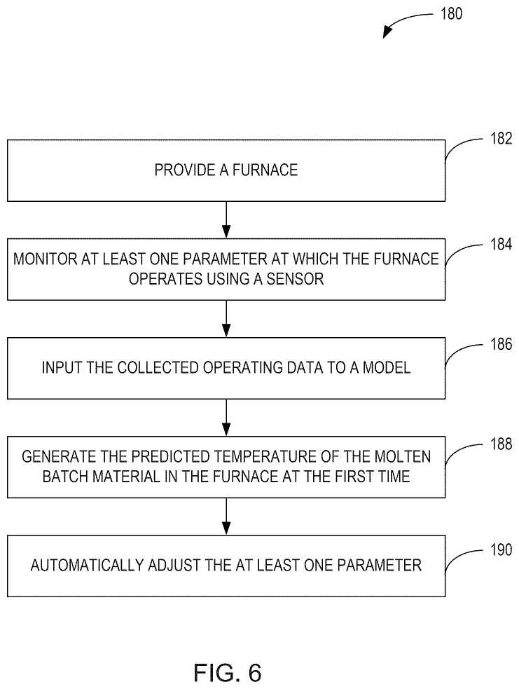

Referring to FIG. 6, a method 180 for operating a furnace is shown according to some non-limiting embodiments or aspects.

At a step 182, the method 180 may include providing a furnace comprising an inlet into which batch materials are fed and an outlet from which a product produced from the batch material emerges, wherein the batch materials within the furnace melt to form a molten batch material.

At a step 184, the method 180 may include monitoring at least one parameter at which the furnace operates using at least one sensor to collect operating data, the at least one parameter monitored not comprising a temperature measurement of the molten batch material in the furnace.

At a step 186, the method 180 may include inputting the collected operating data into a model configured to generate a predicted temperature of the molten batch material in the furnace at a first time in the future, the model trained on historical operating data of the furnace.

At a step 188, the method 180 may include generating, with the model, the predicted temperature of the molten batch material in the furnace at the first time.

At a step 190, the method 180 may include automatically adjusting the at least one parameter based on the predicted temperature of the molten batch material in the furnace at the first time.

The following numbered clauses are illustrative of various aspects of the disclosure:

Clause 1: A method for operating a furnace, comprising: providing a furnace comprising an inlet into which batch materials are fed and an outlet from which a product produced from the batch material emerges, wherein the batch materials within the furnace melt to form a molten batch material; monitoring at least one parameter at which the furnace operates using at least one sensor to collect operating data, the at least one parameter monitored not comprising a temperature measurement of the molten batch material in the furnace; inputting the collected operating data into a model configured to generate a predicted temperature of the molten batch material in the furnace at a first time in the future, the model trained on historical operating data of the furnace; generating, with the model, the predicted temperature of the molten batch material in the furnace at the first time; and automatically adjusting the at least one parameter based on the predicted temperature of the molten batch material in the furnace at the first time.

Clause 2: The method of clause 1, wherein inputs to the inlet comprise: a first input comprising the batch material, a second input comprising an oxygen-containing stream, and a third input comprising a fuel-containing stream.

Clause 3: The method of clause 1 or 2, wherein the at least one parameter comprises at least one of the following: a crown temperature of the furnace, a temperature of gas at the inlet, a flow rate of gas to the furnace, a target amount of product produced, a temperature of the batch material at the inlet, a cullet ratio, an oxygen amount, an environmental variable, a time delay in a production process, and/or any combination thereof.

Clause 4: The method of any of clauses 1-3, further comprising: generating an energy balance model for the furnace, wherein the model generates the predicted temperature of the molten batch material in the furnace at the first time based on the energy balance model.

Clause 5: The method of clause 4, further comprising: training the model based on the energy balance model for the furnace and the historical operating data of the furnace.

Clause 6: The method of clause 5, further comprising: arranging a physical temperature sensor in the molten batch material in the furnace during a training period; operating the furnace to produce the product during the training period; during the training period, collecting the historical operating data of the furnace; and generating the model based on the energy balance model for the furnace and the collected historical operating data of the furnace.

Clause 7: The method of clause 6, further comprising: after generating the model, deactivating the physical temperature sensor from the molten material in the furnace; and operating the furnace to produce the product during a production period without the physical temperature sensor.

Clause 8: The method of clause 6 or 7, further comprising during the training period: compartmentalizing the furnace into a plurality of zones; measuring the parameters at which the furnace operates in each of the plurality of zones; and updating the model based on the measured parameters in each of the plurality of zones.

Clause 9: The method of any of clauses 1-8, wherein automatically adjusting the at least one parameter comprises transmitting a control signal to a component of the furnace to adjust the component of the furnace.

Clause 10: The method of any of clauses 1-9, wherein the batch material comprises a glass batch material, the molten batch material comprises a glass melt, and the product comprises glass.

Clause 11: The method of any of clauses 1-10, wherein before monitoring the at least one parameter at which the furnace operates using the at least one sensor to collect operating data, the method comprises: monitoring a temperature of the molten batch material in the furnace with a temperature sensor during a first time period; inputting the monitored temperature of the molten batch material in the furnace with the temperature sensor during the first time period into the model configured to generate a predicted temperature of the molten batch material in the furnace at a time in the future relative to the first time period, the predicted temperature of the molten batch material in the furnace at a time in the future relative to the first time period based at least partially on the monitored temperature of the molten batch material in the furnace with the temperature sensor during the first time period.

Clause 12: The method of any of clauses 1-11, wherein before monitoring the at least one parameter at which the furnace operates using the at least one sensor to collect operating data, the method comprises: taking a first temperature measurement of the molten batch material in the furnace at the first time with a temperature sensor; and determining that the first temperature measurement fails to satisfy a threshold, the method further comprising: in response to determining that the first temperature measurement fails to satisfy the threshold, generating, with the model, the predicted temperature of the molten batch material in the furnace at the first time.

Clause 13: The method of any of clauses 1-12, further comprising: determining a production schedule change of the furnace, the production schedule change occurring before the first time; inputting the production schedule change to the model; and generating, with the model, the predicted temperature of the molten batch material in the furnace at the first time based at least partially on the production schedule change.

Clause 14: The method of any of clauses 1-13, further comprising: determining a desired temperature of the molten batch material in the furnace at the first time; comparing the desired temperature of the molten batch material in the furnace at the first time to the predicted temperature of the molten batch material in the furnace at the first time; determining that adjusting the at least one parameter to an adjusted setpoint is predicted to achieve the desired temperature of the molten batch material in the furnace at the first time; and automatically adjusting the at least one parameter to the adjusted setpoint.

Clause 15: The method of any of clauses 1-14, further comprising: determining a type of the product produced from the batch materials, the type of product selected from a plurality of different products; based on the type of product, selecting the model from a plurality of different models, the model trained on historical operating data of the furnace for producing the type of product.

Clause 16: A furnace system, comprising: a furnace comprising an inlet into which a batch material is fed and an outlet from which a product produced from the batch material emerges, wherein the batch materials within the furnace melt to form a molten batch material; at least one sensor configured to monitor at least one parameter at which the furnace operates by collecting operating data, the at least one parameter monitored not comprising a temperature measurement of the molten batch material being produced in the furnace; and at least one processor configured to: input the collected operating data into a model configured to generate a predicted temperature of the molten batch material in the furnace at a first time in the future, the model trained on historical operating data of the furnace; generate, with the model, the predicted temperature of the molten batch material in the furnace at the first time; and automatically adjust the at least one parameter based on the predicted temperature of the product in the furnace at the first time.

Clause 17: The system of clause 16, wherein inputs to the inlet comprise: a first input comprising the batch material, a second input comprising an oxygen-containing stream, and a third input comprising a fuel-containing stream.

Clause 18: The system of clause 16 or 17, wherein the at least one parameter comprises at least one of the following: a crown temperature of the furnace, a temperature of gas at the inlet, a flow rate of gas to the furnace, a target amount of product produced by the furnace, a temperature of the molten batch material at the inlet, a cullet ratio, an oxygen amount, an environmental variable, a time delay in a production process, and/or any combination thereof.

Clause 19: The system of any of clauses 16-18, wherein the model generates the predicted temperature of the molten batch material in the furnace at the first time based on an energy balance model generated for the furnace.

Clause 20: The system of clause 19, the at least one processor configured to: train the model based on the energy balance model for the furnace and the historical operating data of the furnace.

Clause 21: The system of clause 20, comprising: a physical temperature sensor arranged in the molten batch material in the furnace during a training period, the furnace operated to produce the product during the training period, the at least one sensor collecting the historical operating data of the furnace during the training period, and the model generated based on the energy balance model for the furnace and the collected historical operating data of the furnace.

Clause 22: The system of clause 21, wherein after generating the model, the physical temperature sensor is deactivated from the molten batch material in the furnace, and the furnace is operated to produce the product during a production period without the physical temperature sensor.

Clause 23: The system of clause 21 or 22, wherein, during the training period the furnace is compartmentalized into a plurality of zones, the at least one sensor is configured to measure the parameters at which the furnace operates in each of the plurality of zones, and the model is updated based on the measured parameters in each of the plurality of zones.

Clause 24: The system of any of clauses 16-23, wherein automatically adjusting the at least one parameter comprises the at least one processor transmitting a control signal to a component of the furnace to adjust the component of the furnace.

Clause 25: The system of any of clauses 16-24, wherein the batch material comprises a glass batch material, the molten batch material comprises a glass melt, and the product comprises glass.

Clause 26: The system of any of clauses 16-25, wherein before monitoring the at least one parameter at which the furnace operates using the at least one sensor to collect operating data, the at least one processor is configured to: monitor a temperature of the molten batch material in the furnace with a temperature sensor during a first time period; input the monitored temperature of the molten batch material in the furnace with the temperature sensor during the first time period into the model configured to generate a predicted temperature of the molten batch material in the furnace at a time in the future relative to the first time period, the predicted temperature of the molten batch material in the furnace at a time in the future relative to the first time period based at least partially on the monitored temperature of the molten batch material in the furnace with the temperature sensor during the first time period.

Clause 27: The system of any of clauses 16-26, wherein before monitoring the at least one parameter at which the furnace operates using the at least one sensor to collect operating data, the at least one processor is configured to: take a first temperature measurement of the molten batch material in the furnace at the first time with a temperature sensor; and determine that the first temperature measurement fails to satisfy a threshold, the at least one processor further configured to: in response to determining that the first temperature measurement fails to satisfy the threshold, generate, with the model, the predicted temperature of the molten batch material in the furnace at the first time.

Clause 28: The system of any of clauses 16-27, the at least one processor further configured to: determine a production schedule change of the furnace, the production schedule change occurring before the first time; inputting the production schedule change to the model; and generate, with the model, the predicted temperature of the molten batch material in the furnace at the first time based at least partially on the production schedule change.

Clause 29: The system of any of clauses 16-28, the at least one processor further configured to: determine a desired temperature of the molten batch material in the furnace at the first time; compare the desired temperature of the molten batch material in the furnace at the first time to the predicted temperature of the molten batch material in the furnace at the first time; determine that adjusting the at least one parameter to an adjusted setpoint is predicted to achieve the desired temperature of the molten batch material in the furnace at the first time; and automatically adjust the at least one parameter to the adjusted setpoint.

Clause 30: The system of any of clauses 16-29, the at least one processor further configured to: determine a type of the product produced from the batch materials, the type of product selected from a plurality of different products; based on the type of product, select the model from a plurality of different models, the model trained on historical operating data of the furnace for producing the type of product.

### EXAMPLES

### Example 1

### Training and Validating a Model

A furnace for producing glass is provided. The furnace has an inlet to which a mixture of glass batch materials and cullet (and/or recycled glass) are fed. The glass batch materials are melted in the furnace to form a glass melt in the furnace. A glass sheet is produced from the glass melt.

The furnace is compartmentalized into the following three zones: (1) a melt zone; (2) a peak zone; and (3) a waist zone.

A model is generated for the furnace according to one or more of the energy balance models 170a-d described herein.

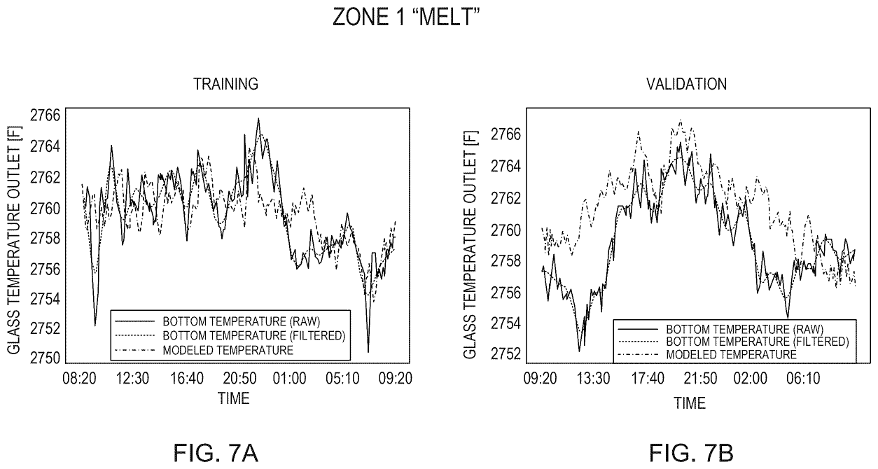

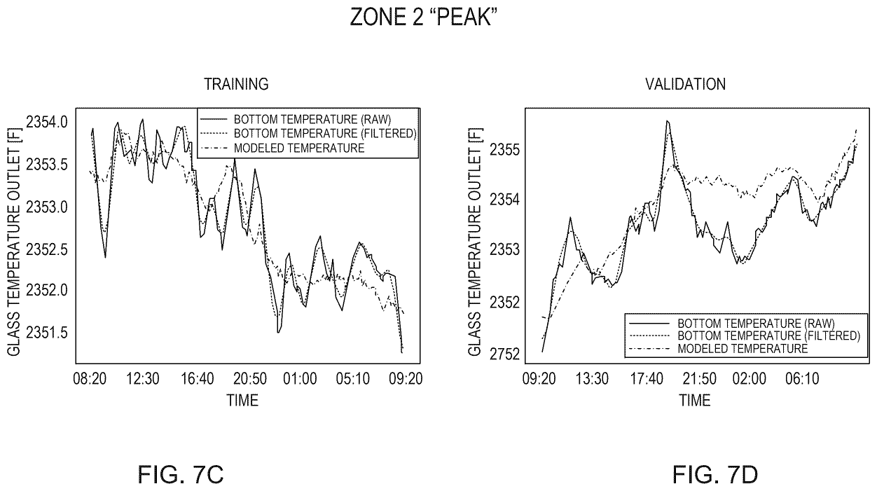

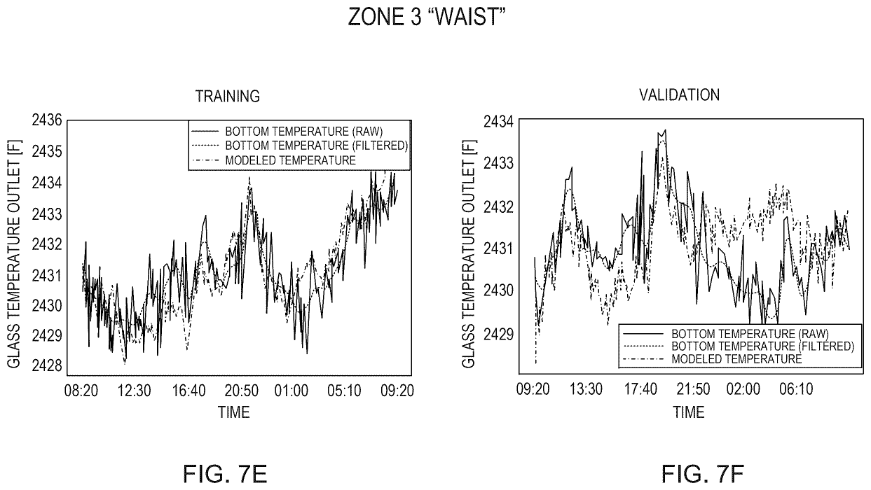

The model is trained using training data collected for the furnace during a training period. FIGS. 7A, 7C, and 7E show training data of glass temperature of the outlet (° F.) during an approximately 1 day period, the temperature lines representing a raw bottom temperature, a filtered bottom temperature, and a modeled temperature.

After completion of the training, the model was validated during a validation time period to determine the efficacy of the trained model. FIGS. 7B, 7D, and 7F show validation data of glass temperature of the outlet (° F.) during an approximately 1 day period, the temperature lines representing a raw bottom temperature, a filtered bottom temperature, and a modeled temperature.

The model observed during this validation period performed well (accurately) when comparing the modeled temperatures to the corresponding actual temperatures.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method for operating a furnace, comprising:
providing a furnace comprising an inlet into which batch materials are fed and an outlet from which a product produced from the batch material emerges, wherein the batch materials within the furnace melt to form a molten batch material;
monitoring at least one parameter at which the furnace operates using at least one sensor to collect operating data, the at least one parameter monitored not comprising a temperature measurement of the molten batch material in the furnace;
inputting the collected operating data into a model configured to generate a predicted temperature of the molten batch material in the furnace at a first time in the future, the model trained on historical operating data of the furnace;
generating, with the model, the predicted temperature of the molten batch material in the furnace at the first time; and
automatically adjusting the at least one parameter based on the predicted temperature of the molten batch material in the furnace at the first time.

2. The method of claim 1, wherein inputs to the inlet comprise: a first input comprising the batch material, a second input comprising an oxygen-containing stream, and a third input comprising a fuel-containing stream.

3. The method of claim 1, wherein the at least one parameter comprises at least one of the following: a crown temperature of the furnace, a temperature of gas at the inlet, a flow rate of gas to the furnace, a target amount of product produced, a temperature of the batch material at the inlet, a cullet ratio, an oxygen amount, an environmental variable, a time delay in a production process, and/or any combination thereof.

4. The method of claim 1, further comprising:
generating an energy balance model for the furnace, wherein the model generates the predicted temperature of the molten batch material in the furnace at the first time based on the energy balance model.

5. The method of claim 4, further comprising:
training the model based on the energy balance model for the furnace and the historical operating data of the furnace.

6. The method of claim 5, further comprising:
arranging a physical temperature sensor in the molten batch material in the furnace during a training period;
operating the furnace to produce the product during the training period;
during the training period, collecting the historical operating data of the furnace; and
generating the model based on the energy balance model for the furnace and the collected historical operating data of the furnace.

7. The method of claim 6, further comprising:
after generating the model, deactivating the physical temperature sensor from the molten material in the furnace; and
operating the furnace to produce the product during a production period without the physical temperature sensor.

8. The method of claim 6, further comprising during the training period:
compartmentalizing the furnace into a plurality of zones;
measuring the parameters at which the furnace operates in each of the plurality of zones; and
updating the model based on the measured parameters in each of the plurality of zones.

9. The method of claim 1, wherein automatically adjusting the at least one parameter comprises transmitting a control signal to a component of the furnace to adjust the component of the furnace.

10. The method of claim 1, wherein the batch material comprises a glass batch material, the molten batch material comprises a glass melt, and the product comprises glass.

11. The method of claim 1, wherein before monitoring the at least one parameter at which the furnace operates using the at least one sensor to collect operating data, the method comprises:
monitoring a temperature of the molten batch material in the furnace with a temperature sensor during a first time period;
inputting the monitored temperature of the molten batch material in the furnace with the temperature sensor during the first time period into the model configured to generate a predicted temperature of the molten batch material in the furnace at a time in the future relative to the first time period, the predicted temperature of the molten batch material in the furnace at a time in the future relative to the first time period based at least partially on the monitored temperature of the molten batch material in the furnace with the temperature sensor during the first time period.

12. The method of claim 1, wherein before monitoring the at least one parameter at which the furnace operates using the at least one sensor to collect operating data, the method comprises:
taking a first temperature measurement of the molten batch material in the furnace at the first time with a temperature sensor; and
determining that the first temperature measurement fails to satisfy a threshold, the method further comprising:
in response to determining that the first temperature measurement fails to satisfy the threshold, generating, with the model, the predicted temperature of the molten batch material in the furnace at the first time.

13. The method of claim 1, further comprising:
determining a production schedule change of the furnace, the production schedule change occurring before the first time;
inputting the production schedule change to the model; and
generating, with the model, the predicted temperature of the molten batch material in the furnace at the first time based at least partially on the production schedule change.

14. The method of claim 1, further comprising:
determining a desired temperature of the molten batch material in the furnace at the first time;
comparing the desired temperature of the molten batch material in the furnace at the first time to the predicted temperature of the molten batch material in the furnace at the first time;
determining that adjusting the at least one parameter to an adjusted setpoint is predicted to achieve the desired temperature of the molten batch material in the furnace at the first time; and
automatically adjusting the at least one parameter to the adjusted setpoint.

15. The method of claim 1, further comprising:
determining a type of the product produced from the batch materials, the type of product selected from a plurality of different products;
based on the type of product, selecting the model from a plurality of different models, the model trained on historical operating data of the furnace for producing the type of product.

16. A furnace system, comprising:
a furnace comprising an inlet into which a batch material is fed and an outlet from which a product produced from the batch material emerges, wherein the batch materials within the furnace melt to form a molten batch material;
at least one sensor configured to monitor at least one parameter at which the furnace operates by collecting operating data, the at least one parameter monitored not comprising a temperature measurement of the molten batch material being produced in the furnace; and
at least one processor configured to:
input the collected operating data into a model configured to generate a predicted temperature of the molten batch material in the furnace at a first time in the future, the model trained on historical operating data of the furnace;
generate, with the model, the predicted temperature of the molten batch material in the furnace at the first time; and
automatically adjust the at least one parameter based on the predicted temperature of the product in the furnace at the first time.

17. The system of claim 16, wherein inputs to the inlet comprise: a first input comprising the batch material, a second input comprising an oxygen-containing stream, and a third input comprising a fuel-containing stream.

18. The system of claim 16, wherein the at least one parameter comprises at least one of the following: a crown temperature of the furnace, a temperature of gas at the inlet, a flow rate of gas to the furnace, a target amount of product produced by the furnace, a temperature of the molten batch material at the inlet, a cullet ratio, an oxygen amount, an environmental variable, a time delay in a production process, and/or any combination thereof.

19. The system of claim 16, wherein the model generates the predicted temperature of the molten batch material in the furnace at the first time based on an energy balance model generated for the furnace.

20. The system of claim 19, the at least one processor configured to:
train the model based on the energy balance model for the furnace and the historical operating data of the furnace.
